(19) United States
(12) Patent Application Publication
(10) Pub. No.: US 2018/0131142 A1
(43) Pub. Date: May 10, 2018

(54) SMART MEDIA CABLE

(71) Applicant: Caavo Inc, Milpitas, CA (US)

(72) Inventors: Sharath Hariharpur Satheesh, Bangalore (IN); Ashish Dharmpal Aggarwal, Stevenson Ranch, CA (US); Pankaj Ramesh Chandra Katiyar, Nagpur (IN)

(21) Appl. No.: 15/808,683

(22) Filed: Nov. 9, 2017

Related U.S. Application Data
(60) Provisional application No. 62/420,250, filed on Nov. 10, 2016.

(51) Int. Cl. H01R 13/717; H04Q 1/02; H01R 13/66

(52) U.S. Cl. CPC H01R 13/7175; G08B 6/00; H01R 13/6691; H04Q 1/136

(57) ABSTRACT

Methods, systems, and apparatuses are described for a media cable. The media cable includes a plurality of conductors, a first connector at a first end of the media cable configured to connect to a first device, a second connector at a second end of the media cable configured to connect to a second device, and a detection circuit. The first connector and the second connector each include a respective plurality of terminals coupled to the plurality of conductors. The detection circuit includes detection logic configured to detect at least one of a state or a state change of at least one of the first device, the second device, or the media cable and an indicator configured to generate a notification of the at least one of the state or the state change.

### CROSS-REFERENCE TO RELATED APPLICATIONS

The present application claims priority to U.S. Application Ser. No. 62/420,250, entitled “SMART HDMI CABLE,” filed on Nov. 10, 2016, the entirety of which is incorporated by reference herein.

### BACKGROUND

### I. Technical Field

The present application relates to media cables that connect devices in a media system.

### II. Background Art

HDMI (high definition multimedia interface) is one of the fastest growing interfaces for audio and video consumption in the world today. A typical household media center has about 3 or 4 audio/video (A/V) devices connected to a television (TV) or high definition TV (HDTV). These devices typically include a cable/satellite TV set top box (STB), an audio system, a Blu-ray® or DVD (digital versatile disc) player, a digital media adapter, a game console, and so on.

Most of these devices now come with a high-speed HDMI connector to allow transfer of high resolution video and audio from the source device (Blu-ray® player, cable TV set top box, etc.) to the sink device (typically the television). By its very nature, this is a many-to-one configuration (many sources connected to a sink).

In order to manage multiple devices, an HDMI repeater/switch is used between the sink and the many sources that allows a user to switch amongst the sources without having to physically swap out cables every time. Many televisions also incorporate switch functionality such that multiple HDMI sources are connected directly to a television. Many televisions, however, have a limited number of inputs for source devices.

As the number of devices relying on HDMI cable connections increases in a household media center, it becomes harder for users to remember which HDMI cable connects a particular source device to a sink device. Further, it may be difficult for users to identify and/or make HDMI cable connections between devices because many HDMI cables are often intertwined in difficult to access spaces.

HDMI cables may be marked with numbers or colors to be easily identified. However, number and color indicators are not useful in identifying connections between devices when connectors/ends of HDMI cables are not visible or accessible (such as when devices are in tight spaces, wall-hung, or located in remote locations). Thus, it may be difficult for users to determine how cables are connected (e.g., by tracing one end of the cable to the other end of the cable to determine interconnections between devices). Devices themselves may also be inaccessible (such as devices in racks or closets), causing additional difficulty in determining interconnections between devices.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses are described for detection and/or indication of a state or state change of a media cable and/or one or more devices connected to the media cable, substantially as shown in and/or described herein in connection with at least one of the figures, as set forth more completely in the claims.

In one aspect, a media cable includes a plurality of conductors, a first connector at a first end of the media cable configured to connect to a first device, a second connector at a second end of the media cable configured to connect to a second device, and a first detection circuit. The first connector and the second connector each include a respective plurality of terminals coupled to the plurality of conductors. The first detection circuit comprises detection logic configured to detect at least one of a state or a state change of at least one of the first device, the second device, or the media cable, and an indicator configured to receive an indication of the detected at least one of the state or the state change and to generate a notification of the at least one of the state or the state change.

The media cable may include one or more additional detection circuits.

In another aspect, a detection circuit of a media cable includes detection logic configured to detect at least one of a state or a state change of at least one of the media cable or a device connected to the media cable, and an indicator configured to receive an indication of the detected at least one of the state or the state change and to generate a notification based on the at least one of the state or the state change.

In still another aspect, a method in a media cable includes: detecting at least one of a state or a state change of the media cable or a first device connected to the media cable; and generating a notification of the at least one of the state or the state change.

Further features and advantages of embodiments, as well as the structure and operation of various embodiments, are described in detail below with reference to the accompanying drawings. It is noted that the subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a media cable that contains a detection circuit, according to an exemplary embodiment.

FIG. 2 is a block diagram of a media cable including first and second detection circuits, according to an exemplary embodiment.

FIG. 3 is a flowchart of a method for detecting and generating a notification of a state or state change of the media cable and/or media device, according to an exemplary embodiment.

FIG. 4 is a block diagram of a typical HDMI switch configuration that includes one or more media cables, according to an exemplary embodiment.

FIG. 5 is a block diagram of a media system including a media cable having an exemplary detection circuit, according to an embodiment.

FIG. 6 is a block diagram of a media system including a media cable including a detection circuit that includes switch, a multivibrator, and a LED, according to an exemplary embodiment.

FIG. 7 is a flowchart of a method for using a switch to manually generate a notification, according to an exemplary embodiment.

FIG. 8 is a block diagram of a media system including a media cable having a detection circuit that includes a microcontroller, according to an exemplary embodiment.

FIG. 9A is a block diagram of a media system including a media cable that includes a detection circuit having a microcontroller that is coupled to a Display Data Channel (DDC) line of the HDMI cable, according to an exemplary embodiment.

FIG. 9B is a block diagram of a media system including a media cable that includes a detection circuit having a microcontroller that is coupled to a Consumer Electronics Control (CEC) line of the HDMI cable, according to an exemplary embodiment.

FIG. 10 is a block diagram of a media system including a media cable having first and second detection circuits coupled to a Source Device Detection (SDD) line, according to an exemplary embodiment.

FIG. 11 shows a block diagram of a computing device/system in which the techniques disclosed herein may be performed and the embodiments herein may be utilized.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, it should be noted that the drawings/figures are not drawn to scale unless otherwise noted herein.

Numerous exemplary embodiments are now described. Any section/subsection headings provided herein are not intended to be limiting. Embodiments are described throughout this document, and any type of embodiment may be included under any section/subsection. Furthermore, it is contemplated that the disclosed embodiments may be combined with each other in any manner. That is, the embodiments described herein are not mutually exclusive of each other and may be practiced and/or implemented alone, or in any combination.

### II. Example Embodiments

The techniques and embodiments herein provide for novel devices, circuits, systems, and methods for a “smart media cable”. For example, according to embodiments, a media cable (alone or in combination with one or more coupled devices) detects and/or indicates (e.g. visually or aurally) at least one of a state or state change of the media cable itself and/or the one or more devices connected to the media cable. Embodiments described herein alleviate and/or eliminate the above-noted problems by making detection and/or indication of such states and/or state changes more flexible, convenient, and “user friendly.”

As used herein, the term “state” broadly refers to a particular condition that a media cable and/or one or more devices are in at a specific time. For example, state may refer to a connection status of a media cable with one or more devices (e.g., connected/disconnected at one or both ends of the media cable with one or more corresponding devices), a functional status of the media cable and/or the one or more devices (e.g., faulty/operational), a power state of one or more connected devices (e.g., on, standby, off), and the operational status of the one or more connected devices (e.g., for a recording device: recording or not recording; for a playback device: deck active or deck inactive).

As used herein, the term “state change” broadly refers to a media cable and/or one or more devices transitioning from one condition to another different condition. For example, state change may refer to transitioning or changes in connection status of a media cable with one or more devices (e.g., connecting/disconnecting and one or both ends), the functional status of the media cable and/or the one or more devices (e.g., faulty/operational), the power state of one or more connected devices (e.g., transitioning from on to standby or from on to off), and the operational status of one or more connected devices (e.g., transitioning from active to inactive).

The example techniques and embodiments described herein may be adapted to various types of media systems and devices, for example but without limitation, communication devices (e.g., cellular and smart phones, etc.), computers/computing devices (e.g., laptops, tablets, desktops, etc.), computing systems, electronic devices, gaming consoles, home electronics and entertainment devices (e.g., home theater systems, stereos, televisions, media players, set top boxes, DVD players, etc.), HDMI switches, repeaters, and/or the like. It is contemplated herein that in various embodiments and with respect to the illustrated figures of this disclosure, one or more components described and/or shown may not be included and that additional components may be included.

As noted above, as the number of devices relying on media cable connections increases in a media system, it becomes more difficult for users to remember which media cable connects a particular source device to a sink device. It may also be difficult for users to identify and/or make media cable connections between devices because many media cables are often intertwined in difficult to access spaces. Moreover, devices themselves may also be inaccessible (such as devices in racks or closets), causing additional difficulty in determining interconnections between devices.

According to embodiments, techniques are provided to alleviate or eliminate these problems in different ways. Such techniques include, without limitation, determining a state or a state change of connected devices and media cables, and providing an indication of the determined state/state change using human detectable notifications (e.g., visual, aural, etc.). For instance, a media cable, such as HDMI cable, may trigger visual and/or aural notifications of the state or the state change based on signal lines available within (e.g., data signal lines, power signal lines, etc.) by incorporating state/state change detection functionality, such as active logic circuitry or low powered microcontrollers, into the media cable.

Various forms of human detectable notifications may be provided. For instance, a visual indication of a state/state change may be provided in various ways, such as by one or more LEDs having one or more colors or patterns (e.g., multi-color pattern). An aural indication may be provided in various ways, such as by one or more speakers that broadcast one or more sounds or tones. Visual and/or aural notifications may be provided in any suitable manner, such as intermittently, periodically, aperiodically (e.g., event-driven), manually, automatically, electromechanically, etc.

Visual and/or aural notifications may be configured to vary based on state. Visual and/or aural notifications may be triggered, for example, by different states or state changes thereto, such as based on static or dynamic (operating) conditions. Examples of triggers for human detectable notifications may include, for example, one or more of the following: (i) state of connection (e.g., cable connection at one or more connectors/ends); (ii) state of disconnection (e.g., at one or more connectors/ends); (iii) power state or change of a source device; (iv) power state or change of a sink device and/or (v) controllable settings (e.g., manually or automatically configured switches).

Notifications indicating triggers/states may be used for a variety of purposes, such as configuration, reconfiguration, calibration, and troubleshooting.

Triggers/states may be detected or sensed and processed, for example, by circuitry (e.g., analog, digital, hybrid, logic, microcontroller) to determine and/or to provide the notifications. For example, a user may depress a button to close a circuit, allowing the circuit to perform a test (e.g., detect continuity, identify an HDMI signal, take one or more samples, execute one or more procedures) to determine one or more states of an HDMI cable and/or devices and provide human detectable feedback to the user to indicate one or more determinations about one or more states relative to the HDMI cable and/or devices. Even though embodiments are described herein in the context of HDMI cables, embodiments may be used to detect and/or indicate states of cables and/or devices of other types (e.g., Universal Serial Bus (USB), Digital Visual Interface (DVI)).

The embodiments described herein reduce confusion and alleviate the complexities noted above, and enable users to determine a state and/or state change of a media cable and/or devices even when connectors/ends of the media cable are not visible or easily accessible.

Various example embodiments are described in the following subsections. It is noted that the division of the following description generally into subsections is provided for ease of illustration, and it is to be understood that any type of embodiment may be described in any subsection.

### III. Example Media Cable Embodiments

Systems and devices may be configured and connected in various ways in media systems. For example, a media cable may be used to interconnect two or more devices. The media cable may be configured, according to embodiments, to detect at least one of a state or a state change of the media cable and/or of the one or more connected devices, and to generate a notification of the state and/or the state change. In this way, a user may be enabled to determine various things, including determining the locations of one or both ends of the media cable, determining whether a source device and/or a sink device is coupled to the media cable, etc.

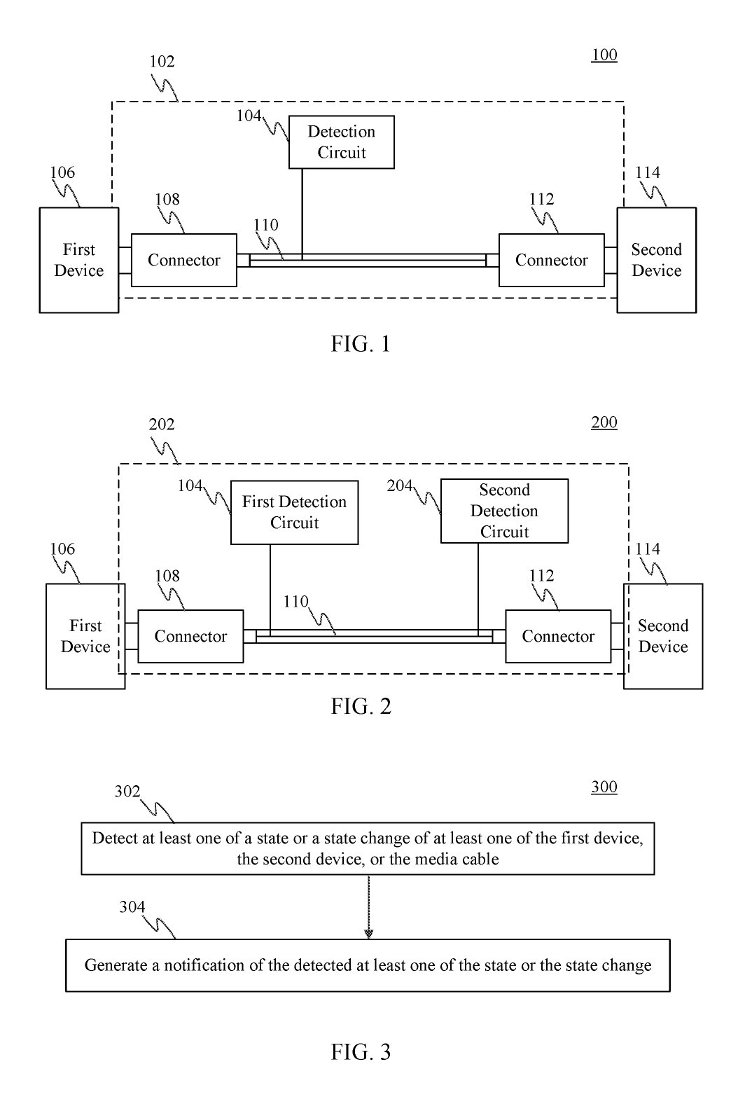

For instance, FIG. 1 shows a media system 100 that includes a smart media cable 102 (“media cable”), according to an example embodiment. Media cable 102 of FIG. 1 is configured to perform methods and/or functions as described in embodiments using components and/or sub-components of the described embodiments. For instance, media cable 102 is configured to detect a state or state change of a media cable (itself) and/or one or more devices, and to generate a notification of the state or state change, according to embodiments.

As shown in FIG. 1, media cable 102 includes a detection circuit 104, a first connector 108, a second connector 112, and a plurality of conductors 110. First connector 108 is positioned at a first end of media cable 102 and is configured to connect to devices (e.g., first device 106). Second connector 112 is positioned at a second end of media cable 102, and is configured to connect to devices (e.g., second device 114). First connector 108 and second connector 112 each include a respective plurality of terminals (e.g., pins, pads, sockets) (not shown in FIG. 1) coupled to conductors 110 (e.g., bundled communication/signal lines, such as wires, etc.).

Detection circuit 104 may be coupled to one or more of the signal lines of conductors 110 and/or to one or more terminals (e.g., pins, pads, sockets) of connectors 108 and 112, and may be positioned anywhere in media cable 102, including at or near an end of media cable 102 (e.g., near first or second connector 108 or 112). Such coupling may comprise direct or indirect connections. For example, as shown in FIG. 1, detection circuit 104 may be coupled to one or more of conductors 110 of media cable 102, and media cable 102 is coupled between a first device 106 and a second device 114, via connector 108 and connector 112, respectively.

Detection circuit 104 may be implemented as hardware (e.g., electrical circuits), or hardware that includes one or both of software (e.g., as executed by a processor or processing device) and firmware. Detection circuit 104 is configured to operate and perform functions according to the embodiments described herein. For example, detection circuit 104 may be configured to detect at least one of a state or a state change of the media cable 102, first device 106, and/or second device 114, and to generate a notification of at least one of the state or the state change. In an embodiment, the detected state and/or state change may include detecting one or more of the following: (i) a connection of media cable 112 to first device 106, (ii) a disconnection of media cable 102 from first device 106, (iii) a connection of the media cable 102 to second device 114, (iv) a disconnection of media cable 102 from second device 114, (v) a power state of first device 106, and (vi) a power state of second device 114. Still further, in an embodiment, the notification of the state or state change may include visual and/or aural aids that vary based on the state or state change.

In embodiments, media cable 102 may be an HDMI cable. To illustrate, media cable 102 may be connected to first device 106, which may be an HDMI-enabled source device (e.g., Blu-ray® player, cable TV set top box), via connector 108 and may be connected to second device 114, which may be an HDMI-enabled sink device (e.g., TV or other display device) via connector 112, where second device 114 receives audio/video (AV) signals provided by first device 106 over conductors 110 of media cable 102.

An HDMI cable may be subject to various standards specifying various static and dynamic (operating) qualities. An HDMI cable may comprise circuitry that does not degrade static or dynamic qualities below relevant HDMI specifications. For example, circuitry may not substantially disrupt or degrade HDMI signals passing through an HDMI cable. A variety of circuitry may provide varying degrees of intelligence to media cable 102, which may be fully or partially automated involving varying degrees of interaction. For example, media cable 102 may be made “smart” by integrating detection circuit 104 in media cable 102, and coupling detection circuit 104 to one or more HDMI conductors of media cable 102.

Note that embodiments, multiple detection circuits 104 may be implemented in media cable 102. For instance, FIG. 2 shows a block diagram of a media system 200 that includes a media cable 202, according to an exemplary embodiment. Media cable 202 is an example embodiment of media cable 102, and thus is generally similar to media cable 102 as described herein with respect to FIG. 1, with differences described as follows. For instance, as shown in FIG. 2, media cable 202 includes multiple detection circuits in the form of first and second detection circuits 104 and 204. In embodiments, detection circuit 204 may be implemented identically or similarly to detection circuit 104, and thus description of the circuits, software, firmware, etc., of detection circuit 104 herein is applicable to embodiments of detection circuit 204.

For example, second detection circuit 204 may be implemented as hardware (e.g., electrical circuits), or hardware combined with one or more of software (e.g., as executed by a processor or processing device) and firmware. Second detection circuit 204 may be configured to detect at least one of a state or a state change of the media cable 202, first device 106, and/or second device 114, and to generate a notification of at least one of the state or the state change. In an embodiment, the detected state and/or state change may include detecting one or more of the following: (i) a connection of media cable 202 to first device 106, (ii) a disconnection of media cable 202 from first device 106, (iii) a connection of media cable 202 to second device 114, (iv) a disconnection of media cable 202 from second device 114, (v) a power state of first device 106, and (vi) a power state of second device 114. Still further, in an embodiment, detection circuit 204 may generate notifications of the state or state change, which may include visual and/or aural aids that vary based on the state or state change.

First detection circuit 104 and second detection circuit 204 may be positioned in media cable 202 in any suitable respective locations, including being positioned at opposite ends of media cable 202, at or near connectors 108 and 112.

In an embodiment, first detection circuit 104 and second detection circuit 204 may be configured to interact (e.g., communicate with) with each other. For example, first detection circuit 104 and second detection circuit 204 may convey their respective states to each other. To further illustrate, first detection circuit 104 may convey that first device 106 is disconnected from media cable 202 or first device 106 is powered off to second detection circuit 204. Similarly, second detection circuit 204 may convey that second device 114 is disconnected from media cable 202 or second device 114 is powered off to first detection circuit 104. In another embodiment, first detection circuit 104 and second detection circuit 204 may be configured to operate separately without interacting with each other.

Media cable 102 (including media cable 202) may be implemented, for example at least in part, in the form of operations, procedures, or methods. For instance, FIG. 3 shows a flowchart 300 of a procedure to detect at least one of a state or a state change of a media cable and/or one or more devices, and to generate a notification of the state or the state change, according to an example embodiment. No order of steps is required in flowchart 300 unless expressly indicated or inherently required. Operations may be performed out of order, in an alternate sequence, or partially (or completely) concurrently with each other or with other operations. There is no requirement that an implementation implement all steps shown in FIG. 3. Other examples may contain fewer operations than shown in flowchart 300. Embodiments may implement fewer, more or different steps. Other structural and operational embodiments will be apparent to persons skilled in the relevant art(s) based on discussion herein. Flowchart 300 is described as follows.

In step 302, at least one of a state or a state change of at least one of the first device, the second device, or the media cable is detected. For example, as shown and described with respect to FIGS. 1 and 2, detection circuit 104 and/or second detection circuit 204 may detect at least one of a state or a state change of at least one of first device 106, second device 114, or the media cable 102. For example, detection circuit 104 (and/or detection circuit 204) monitors one or more signal lines (e.g., data signal lines, power signal lines, etc.) of conductors 110, and based thereupon, may detect that first or second device 106 or 114 has been connected to or disconnected from connector 108 or connector 112.

In step 304 of FIG. 3, a notification of the detected at least one of the state or the state change is generated. For example, as shown and described with respect to FIGS. 1 and 2, detection circuit 104 (and/or second detection circuit 204) may generate a notification of the at least one of the state or the state change. The notification can be configured in various ways, including a visual notification (e.g., a light, a message on a display, etc.) and/or an aural notification (e.g., a sound, a voice message, etc.).

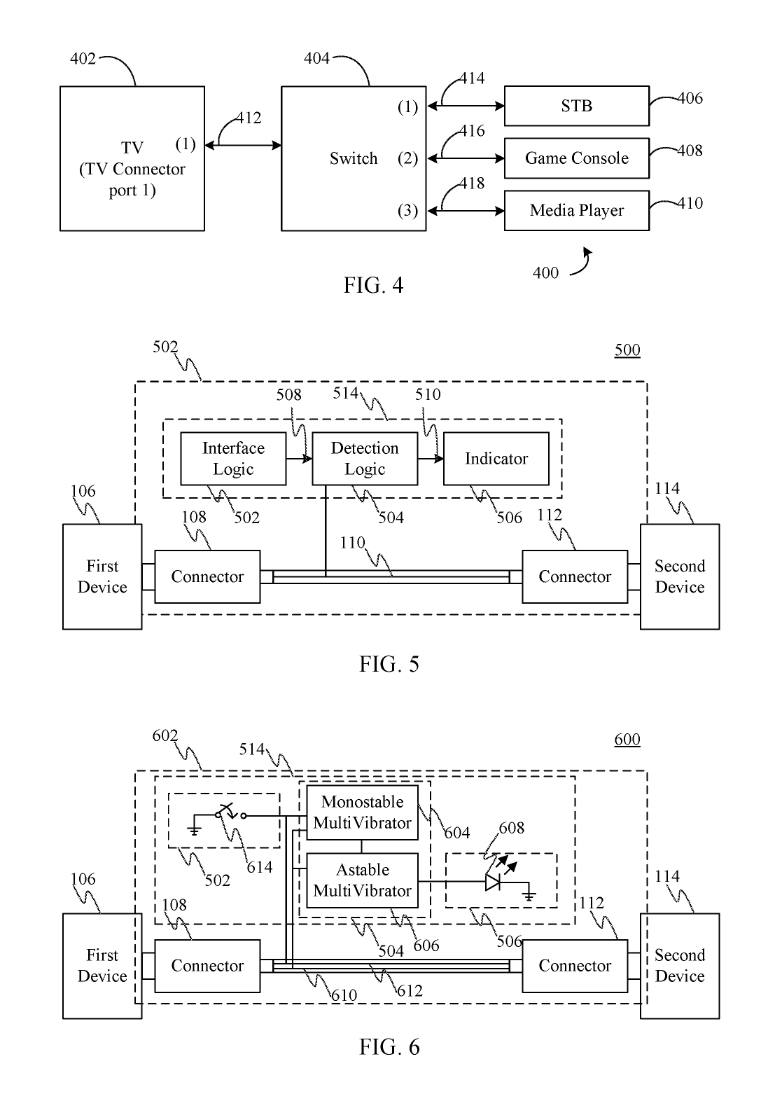

Media cable 102 (including media cable 202) may be implemented in a media system in any suitable location, and any numbers of media cable 102 (including media cable 202) may be implemented in a media system. For instance, an exemplary media system 400 is shown in FIG. 4. As shown in FIG. 4, media system 400 includes a television (TV) 402, a switch 404 (e.g., an HDMI switch), a set top box (STB) 406, a game console 408, a media player 410, and first-fourth media cables 412, 414, 416, and 418. Greater or lesser numbers of devices may be present in media system 400, including alternative devices being present (e.g., a computer, etc.), as well as a corresponding number of media cables being present.

In FIG. 4, a sink device such as TV 402 is connected to switch 404 by media cable 412. STB 406 is connected to switch 404 via media cable 414, game console 408 is connected to switch 404 via media cable 416, and media player (e.g., a video disc player such as a Blu-ray® player, a digital media player or extender such as Amazon Fire® TV, Apple TV®, Google® Chromecast™, Roku®, etc.) 410 is connected to switch 404 via media cable 418. In embodiments, any one or more of media cables 412, 414, 416, and 418 may be configured as media cable 102 of FIG. 1, media cable 202 of FIG. 2, or any other media cable embodiment disclosed herein.

Detection circuits (e.g., detection circuit 104 and detection circuit 204) may be configured in various ways to perform their functions, in embodiments. For instance, FIG. 5 is a block diagram of a media system 500 including a media cable 502 that includes a detection circuit 514, according to an embodiment. Media cable 502 is an example of media cable 102, and detection circuit 514 is an example of detection circuit 104. As shown in FIG. 5, detection circuit 514 includes an interface logic 502, a detection logic 504, and an indicator 506. These components of detection circuit 514 are described as follows.

Interface logic 502 is configured to detect a state/trigger and provide detection logic 504 with an indication that the state/trigger was detected. Interface logic 502 may include one or more components/devices that a user or machine may interact with to make a selection, complete a circuit, reset a circuit, and/or cause other input to detection circuit 514 to manually trigger detection circuit 514. For example, interface logic 502 may include an interactive component (e.g., a button) that detects user input (e.g., pressing or depressing of the button). When the user input is detected, interface logic 502 generates a trigger signal 508, causing a state change to media cable 102 (at least temporarily).

Detection logic 504 is configured to detect at least one of a state or state change of a media cable and/or one or more devices and provide an indication of the at least one of the state or the state change to indicator 506. For example, in an embodiment, detection logic 504 may receive trigger signal 508, which is an indication of a state change to media cable 502 by a user interacting with interface logic 502. As another example, detection logic 504 may detect a state and/or state change for first device 106 and/or second device 114 (e.g., disconnection of device 106 from media cable 102) by monitoring one or more signal lines of conductors 110. Detection logic 504 may include, for example, circuitry, which may be digital, analog, mixed, one or more sensors, one or more controllers or processors, one or more storage or memory devices with integrated or discrete components configured to perform the detecting. In one example, detection logic 504 may include an ultra-low power microcontroller or combination logic. As shown in FIG. 5, detection logic 504 generates detected state indication 510, which includes an indication of the detected state and/or state change. For instance, detected state indication 510 may include a signal voltage or level (e.g., high or low) that provides the indication, may include a digital value that provides the indication, and/or may have other form for providing the indication.

Indicator 506 is configured to receive detected state indication 510 as the indication of the state and/or state change from detection logic 504, and to generate a notification based on the state and/or state change. Indicator 506 may include one or more sensory feedback and/or notification devices/components that generate one or more notifications detectable by one or more human senses, such as visual and/or aural indications. For example, indicator 506 may include one or more LEDs that provide a visual notification, one or more speakers that provide an aural notification, one or more oscillating devices that provide aural and/or touch feedback (e.g., vibrations), and so on.

Detection circuit 514 of FIG. 5 may be configured in various ways to perform its functions, in embodiments. For instance, FIG. 6 is a block diagram of a media system 600 including a media cable 602 that includes detection circuit 514, according to an embodiment. Media cable 602 is an example embodiment of media cable 102. As shown in FIG. 6, detection circuit 514 includes interface logic 502, detection logic 504, and indicator 506. Interface logic 502 includes a switch 614, detection logic 504 includes a monostable multivibrator (MSMV) 604 and an astable multivibrator (ASMV) 606, and indicator 506 includes a LED 608. These components of media cable 602 are described as follows.

In an embodiment, media cable 602 may be an HDMI cable. In such an embodiment, media cable 602 may include elements and/or characteristics that are specific to an HDMI cable, including the transmission of video data of various formats, as well as clock signal, a power signal, and a ground signal on respective conductors of conductors 110. As such, the monitoring, detection, processing, and determination of a state or a state change by media cable 102 may be based on (e.g., may vary based on) one or more HDMI signals. For instance, a Hot Plug Detect (HPD) line of an HDMI cable may be used to sense when a device is connected or disconnected from the HDMI cable. To illustrate, a source device provides a +5V power signal on a conductor when connected to an HDMI cable and a sink device, when connected to the HDMI cable, provides a voltage signal (e.g., +5V) on a HPD signal conductor after detecting the power voltage signal (e.g., +5V) from the source device. The presence or absence of these signals on signal lines of conductors 110 may be detected by detection circuit 514 to determine state changes by sink and/or source devices.

In embodiments, an HPD-based scheme may be implemented by detection logic 504 with one or more pulse generators and/or oscillating circuits, such as multi-vibrators. Example types of multivibrators include a monostable multivibrator (MSMV) and an astable multivibrator (ASMV). A MSMV circuit has two states, in which one of the states is stable and the other state is unstable (transient). A trigger pulse may cause the MSMV circuit to enter the unstable state. After entering the unstable state, the MSMV circuit returns to the stable state after a configurable set time. In contrast, an ASMV circuit also has two states, in which the ASMV circuit is not stable in either state. When triggered by an input trigger pulse, ASMV circuit continually switches between the unstable states according to a configurable period.

To illustrate the HPD-based scheme described above, referring to FIG. 6, ASMV 606 and MSMV 604 receive a power signal from a conductor of media cable 602, shown as +5V line 610, and MSMV 604 is coupled to a hot-plug detect conductor of media cable 602, shown as an HPD line 612. Furthermore, LED 608 of indicator 506 is coupled between ASMV 606 and ground, and switch 614 of interface logic 502 is coupled between ground and HPD line 612.

In an embodiment, HPD line 612 may change state (e.g., toggle), indicating a disconnection of first device 106 from media cable 102, which is detected by MSMV 604. In response to receiving the state change on HPD line 612 as an input trigger signal, MSMV 604 generates an active high pulse for a configurable period (e.g., a timing parameter set by selection of a resistor-capacitor (R-C) constant, etc.). This active high pulse is received by ASMV 606, causing ASMV 606 to output its unstable (oscillating) output signal (having a timing parameter of a period configurable according to an R-C constant or other manner). This output signal of ASMV 606 is received by LED 608, causing LED 608 to emit light on and off according to the period of the output signal of ASMV 606. The duration of LED 608 blinking is controlled by the timing parameter of MSMV 604, and the blink frequency of LED 608 is controlled by the timing parameter of ASMV 606.

In this manner, detection logic 514 of media cable 602 determines state changes in the sink device (e.g., second device 114) that provides the +5V on HPD line 612. When second device 114 is the sink device, and is connected or disconnected from media cable 502, HPD line 612 changes state (toggles), and causing detection circuit 514 to flash LED 608 at a frequency for a period of time, alerting a user of this change of state of second device 114.

Furthermore, when switch 614 is actuated, pulling HPD line 612 to ground, detection logic 504 is triggered as described above for the state change in HPD line 512. For example, pulling HPD line 612 to ground by actuating switch 614 may trigger MSMV 604 to generate an active high pulse for a period, which triggers ASMV 606 to output the unstable output signal, which toggles LED 608 for the configurable time period.

In this manner, a user may actuate switch 614 to cause detection circuit 514 to flash LED 608 at a frequency for predetermined time period. This may be performed so that the user can test the capability (e.g., faulty or operational) of detection circuit 514, and/or so that the user can cause the end (or ends) of media cable 502 to be illuminated by LED 608 (where LED 608 is positioned), so the user can visually ascertain whether connectors 108 and/or 112 are properly connected to the respective source and/or sink device connectors.

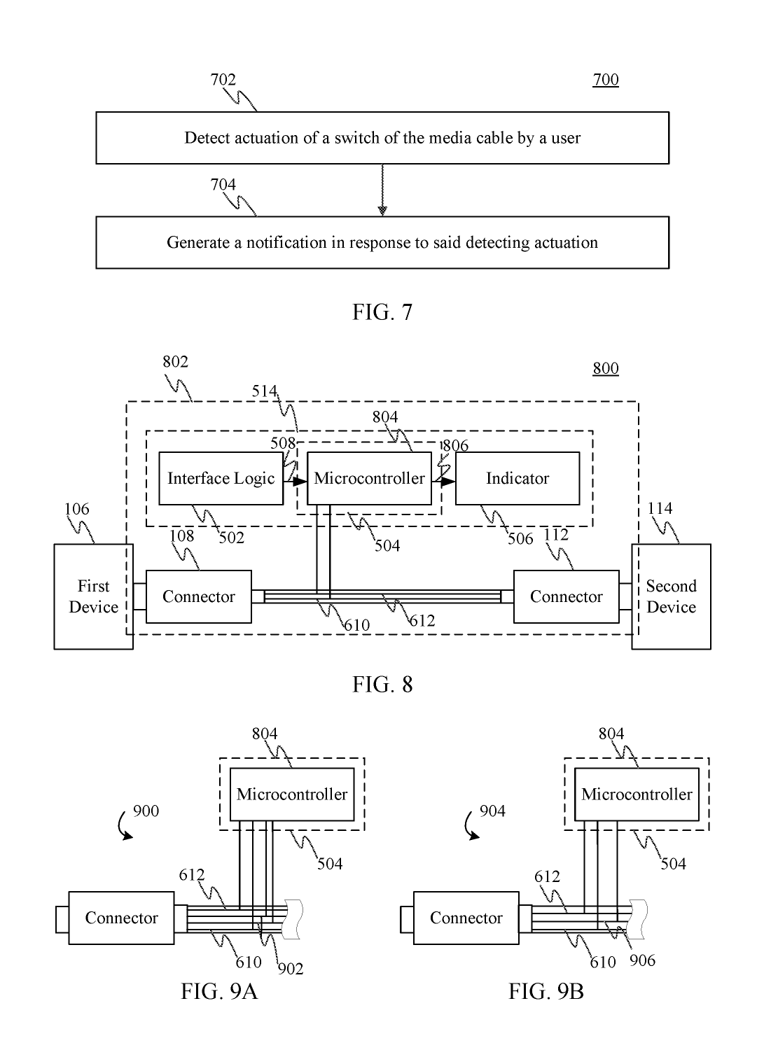

For instance, detection circuit 602 may operate according to FIG. 7. FIG. 7 shows a flowchart 700 of a procedure to manually generate a notification in response to actuation of a switch, according to an example embodiment. Embodiments may implement additional steps to those shown in FIG. 7. Other structural and operational embodiments will be apparent to persons skilled in the relevant art(s) based on discussion herein. Flowchart 700 is described as follows.

In step 702, actuation of a switch of the media cable by a user is detected. For example, as shown and described with respect to FIGS. 5 and 6, interface logic 502 may detect actuation of switch 614 of media cable 602 by a user. For example, in an embodiment, switch 614 may be a toggle switch and may be actuated by a lever angled in one of two or more positions. In another embodiment, switch 614 may be a pushbutton switch and is actuated by a button being pressed and released. Switch 614 may be implemented in other ways in other embodiments.

In step 704 of FIG. 7, a notification in response to said detecting actuation is generated. For example, as described with respect to FIGS. 5 and 6, interface logic 502 generates a notification (e.g., trigger signal 508) in response to said detecting actuation of switch 614 that is received by detection logic 504. For instance, as described with respect to FIG. 6, when switch 614 is actuated, the state of HPD line 612 is changed (e.g., pulled to ground), triggering detection logic 504 to generate detected state indication 510, which causes LED 608 to emit light in a constant or blinking manner for a predetermined time period.

In another embodiment, detection logic 504 of FIG. 5 may include one or more microcontrollers (in addition to or as an alternative to multivibrators) that are used to detect states/state changes. For instance, FIG. 8 is a block diagram of a media system 800 including a media cable 802 that includes detection circuit 514, according to an embodiment. Media cable 802 is an example embodiment of media cable 102. As shown in FIG. 8, detection circuit 514 includes interface logic 502, detection logic 504, and indicator 506. Detection logic 504 includes a microcontroller 804. The components of media cable 802 not already described elsewhere herein are described as follows.

In an embodiment, media cable 802 may be an HDMI cable and the HPD-based scheme described above may be implemented by detection logic 504 with one or more microcontrollers. A microcontroller may include memory, programmable input/output peripherals, and one or more processors and may be configured to execute, by the one or more processors, computer executable instructions in the form of software or firmware (e.g., a program, code, or algorithm) stored in memory of the microcontroller and/or in other memory accessible to the microcontroller.

To illustrate the HPD-based scheme described above using microcontrollers, referring to FIG. 8, microcontroller 804 receives a power voltage signal (e.g., +5V) from a conductor of media cable 802 (e.g., the HDMI power signal line), shown as +5V line 610. Furthermore, microcontroller 804 is coupled to a hot-plug detect conductor of media cable 802, shown as HPD line 612, and thus receives the HDP signal.

In an embodiment, microcontroller 804 is configured to monitor HPD line 612 to detect at least one of a state or state change of a media cable and/or one or more devices and to provide an indication of the at least one of the state or the state change to indicator 506 to generate a notification. For instance, HPD line 612 may change state (e.g., toggle from a high state to a low state), indicating a disconnection of first device 106 (which had generated the HPD signal when connected) from media cable 802. In response to receiving the state change on HPD line 612 as an input trigger signal, microcontroller 804 may be configured to generate a detected state indication 806, which indicates the detected state and/or state change, to provide to indicator 506. For instance, detected state indication 806 may include a signal voltage or level (e.g., high or low) that provides the indication, may include a digital value that provides the indication, and/or may have other form for providing the indication.

In this manner, microcontroller 804 is configured to control indicator 506. In embodiments, microcontroller 804 may be programmed to define and/or set at least one of: a type, a duration, or a frequency of a notification of at least one of a state or a state change. In an embodiment in which indicator 506 includes one or more LEDs (as shown in FIG. 6), microcontroller 804 may be programmed by a user (e.g., via a user interface (UI) displayed on a sink device or other device) to control one or more LEDs by setting notification patterns (e.g., LED ON, LED OFF, a blink time of an LED, and/or a blink frequency of an LED, a coded blink sequence, etc.). Further, in embodiments, the programmed notifications may be predefined or customized Some examples include: an LED turning off may represent a media cable being connected to a device; a first blink pattern may represent a media cable being connected to a source device but the source device is powered off; a second blink pattern may represent a media cable being disconnected from a device; an LED being on may represent that a media cable is faulty, etc. With customizable notifications, when a problem occurs with a media cable (e.g., a device is disconnected from a media cable) users are able to immediately detect and identify the issue (e.g., a blink pattern indicating that a media cable is disconnected from a device).

Detection logic 504 of FIG. 5 may be coupled to one or more HDMI conductors of a media cable to detect states/state changes, in embodiments. For instance, FIG. 9A shows a block diagram of a portion of a media cable 900 that includes detection circuit 504 having microcontroller 804 coupled to a Display Data Channel (DDC) line of media cable 900, shown as DDC lines 902. Media cable 900 is an example embodiment of media cable 102 and DDC lines 902 are examples of signal lines of conductors 110. These components of media cable 900 are described as follows.

When present, DDC lines are a communication channel of an HDMI cable that carries device information and high-bandwidth digital copy protection (HDCP) encryption information. DDC lines may include one or more Inter-Integrated Circuit (PC or I-squared-C) lines that provide a (e.g., multi-master, multi-slave, single-ended serial) computer bus, which may permit logic (e.g., detection logic 504) to interact (e.g., communicate) with devices connected to an HDMI cable. For instance, a sink device may contain logic (e.g., a circuit and/or software/firmware executed by a processor) configured to detect an absence of a signal on HPD line 612 after a source device is disconnected from media cable 900 and to communicate the absence of the signal to microcontroller 804 over DDC lines 902 using a predetermined digital code. Notification of the absence of the signal may be provided to a user on a display of a sink device, or otherwise indicated to the user, as an indication of the disconnected source device.

Further, microcontroller 804 may be interacted with by one or more users through one or more devices connected to media cable 900 using DDC lines 902, in embodiments. For example, a user may program microcontroller 804 to define and/or set states/triggers and types of notifications associated the states/triggers using DDC lines 902.

As another exemplary embodiment, FIG. 9B shows a block diagram of a portion of a media cable 904 that includes detection circuit 504 having microcontroller 804 coupled to a Consumer Electronics Control (CEC) line of media cable 904, shown as CEC line 906. Media cable 904 is an example embodiment of media cable 102 and CEC line 906 is an example of a signal line of conductors 110. These components of media cable 904 are described as follows.

A CEC line is a communication channel of an HDMI cable that is implemented as a one-wire bidirectional serial bus and enables various HDMI-enabled devices connected through HDMI to interact (e.g., communicate) with each other. In embodiments, the communication scheme, as shown in FIG. 9A, based on DDC lines may be alternatively implemented using a CEC line. For example, a sink device may detect a presence of a signal on HPD line 612 after a source device is connected to media cable 904 and communicate the presence of the signal to microcontroller 804 over CEC line 906. In embodiments, the communication scheme described above may be implemented using one or more DDC lines and a CEC line of the plurality of HDMI conductors of a media cable. For example, a switch (e.g., a smart HDMI switch) may communicate one or more states (e.g., a power state) of several devices the switch is connected to over the one or more DDC lines and the CEC line to a detection circuit of a media cable coupled to the one or more DDC lines and the CEC line. The one or more states of the several devices may be shown to a user on a display of a sink device connected to the media cable.

Another feature of the CEC scheme described above includes vendor specific CEC commands that enable a set of vendor-defined commands to be communicated between devices of that vendor. For example, a device that supports vendor specific CEC commands may store a Vendor ID. A device may accept vendor specific CEC commands from an initiator device of the same Vendor ID. With the agreement of the vendors involved, a device may accept vendor specific CEC commands from devices made by other vendors. In embodiments, vendor specific CEC commands may be used to define and/or set for one or more states/triggers and notifications associated with one or more states/triggers. For example, a user may use vendor specific CEC commands communicated to microcontroller 804 over CEC line 906 to program microcontroller 804 to associate a disconnection of source device from media cable 904 with a notification of a blinking LED.

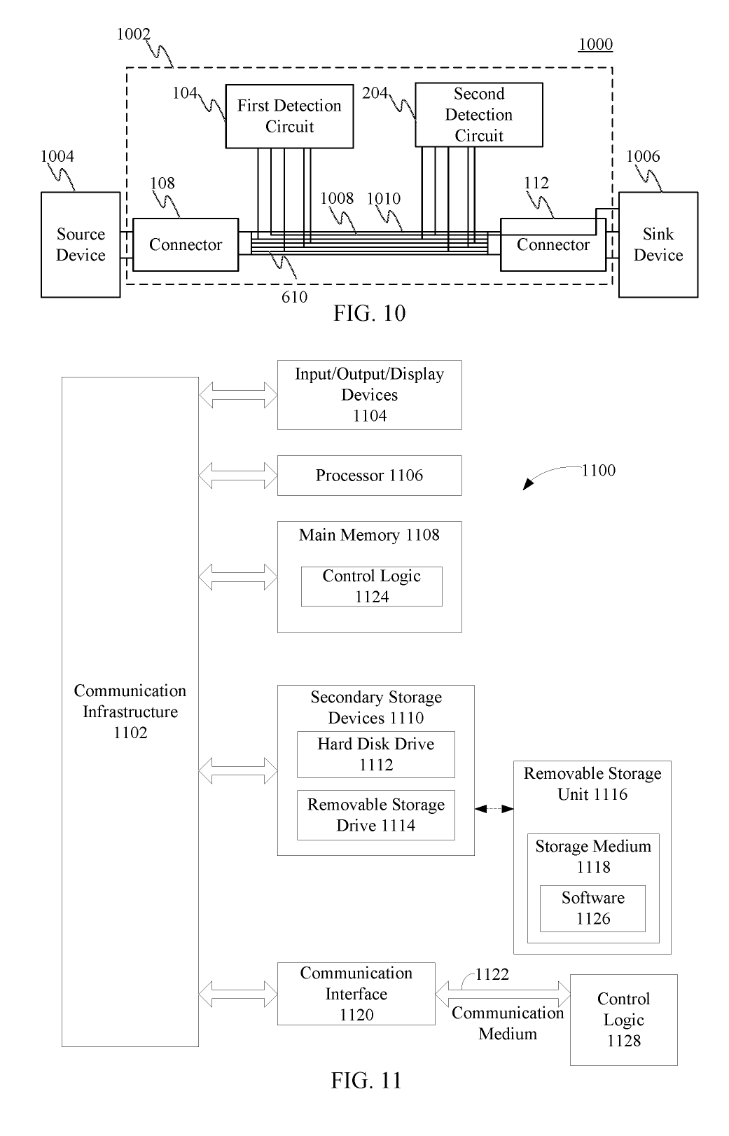

Detection circuit 514 of FIG. 5 may be configured in further ways to perform its functions, in embodiments. For instance, FIG. 10 is a block diagram of a media system 1000 including a media cable 1002 having a detection circuit coupled to a Source Device Detection (SDD) line, according to an exemplary embodiment. As shown in FIG. 10, media cable 1002 includes connector 108, connector 112, first detection circuit 104, second detection circuit 204, and connectors 1010. Second detection circuit 204 is optionally present. Connector 108 is shown connected to a source device 1004, and connector 112 is shown connected to a sink device 1006. Conductors 1010 are connected between connectors 108 and 112. First detection circuit 104 and second detection circuit 204 are coupled to +5V line 610 and an additional power supply line (e.g., +5V) of conductors 1010, shown as SSD line 1008. SSD line 1008 may be routed inside or outside media cable 1002 and in or outside connector 112. Media cable 1002 is an example embodiment of media cable 102 and SSD line 1008 is an example of a signal line of conductors 1010. These components of media cable 1002 are described as follows.

As described above, in embodiments, a power voltage signal (e.g., +5 V line 610) is provided by a source device over an HDMI cable, such as when the source device is connected to a sink device and is active or is in an ON state. However, when the power voltage signal is not detected on the HDMI cable, it may indicate one or more of the following: i) the source device is switched off; ii) the source device is in standby; iii) the HDMI cable between the source device and the sink device is disconnected, iv) the source device has a malfunction and/or v) the HDMI cable has a malfunction.

In FIG. 10, in the instances described above, +5V line 610 may not provide a power voltage signal by source device 1004 to first detection circuit 104 and second detection circuit 204. However, in these instances, SSD line 1008 may provide a power voltage signal to first detection circuit 104 and second detection circuit 204 to enable them to function. For example, SSD line 1008 may power first and second detection circuits 104 and 204 to permit their detecting when connector 112 of media cable 1002 connects or disconnects from sink device 1006 despite source device 1004 being disconnected and not providing a power voltage signal. In embodiments, SDD feature may be used in conjunction with DDC lines and/or CEC line.

The techniques and embodiments herein provide a media cable that may be used to detect and/or to indicate the status of one or more of the media cable and one or more devices.

### III. Further Example Embodiments and Advantages

As noted above, systems and devices may be configured in various ways to detect source devices for media cable configurations, according to the techniques and embodiments provided. For example, embodiments and techniques, including methods, described herein may be performed in various ways such as, but not limited to, being implemented by hardware, or hardware combined with one or both of software and firmware. For example, embodiments may be implemented as systems and devices, such as HDMI systems, schemes, setups, and devices, specifically customized hardware, ASICs, electrical circuitry, and/or the like.

### IV. Example Computer Implementations

Various features of the setups and systems of FIGS. 1-10, along with various features of any respective components/subcomponents thereof, and/or any techniques, further systems, sub-systems, and/or components disclosed and contemplated herein (including claimed subject matter) may be implemented in hardware (e.g., hardware logic/electrical circuitry), or any combination of hardware with one or both of software (computer program code or instructions configured to be executed in one or more processors or processing devices) and firmware.

The embodiments described herein, including HDMI electronics, circuitry, devices, systems, methods/processes, and/or apparatuses, may be implemented in or using well known processing devices, communication systems, servers, and/or, computers (e.g. microcontrollers), such as a processing device 1100 shown in FIG. 11 and/or one or more components therein (e.g. to form a microcontroller). It should be noted that processing device 1100 may represent communication devices/systems, entertainment systems/devices, processing devices, as well as tablets, laptops and/or traditional computers in one or more embodiments. For example, source device detection systems and devices according to the described techniques and embodiments, and any of the sub-systems and/or components respectively contained therein and/or associated therewith, may be implemented in or using one or more processing devices 1100 and similar computing devices.

Processing device 1100 can be any commercially available or proprietary communication device, processing device, and/or computer (e.g. microcontroller) capable of performing the functions described herein, such as, but not limited to, devices/computers available from International Business Machines®, Apple®, Sun®, HP®, Dell®, Cray®, Samsung®, Nokia®, etc. Processing device 1100 may be any type of computer, including a desktop computer, a server, etc., and may be a computing device or system within another device or system.

Processing device 1100 includes one or more processors (also called central processing units, or CPUs), such as a processor 1106. Processor 1106 is connected to a communication infrastructure 1102, such as a communication bus. In some embodiments, processor 1106 can simultaneously operate multiple computing threads, and in some embodiments, processor 1106 may comprise one or more processors.

Processing device 1100 also includes a primary or main memory 1108, such as random access memory (RAM). Main memory 1108 has stored therein control logic 1124 (computer software), and data.

Processing device 1100 also includes one or more secondary storage devices 1110. Secondary storage devices 1110 include, for example, a hard disk drive 1112 and/or a removable storage device or drive 1114, as well as other types of storage devices, such as memory cards and memory sticks. For instance, processing device 1100 may include an industry standard interface, such a universal serial bus (USB) interface for interfacing with devices such as a memory stick. Removable storage drive 1114 represents a floppy disk drive, a magnetic tape drive, a compact disk drive, an optical storage device, tape backup, etc.

Removable storage drive 1114 may interact with a removable storage unit 1116. Removable storage unit 1116 includes a computer useable or readable storage medium 1118 having stored therein computer software 1126 (control logic) and/or data. Removable storage unit 1116 represents a floppy disk, magnetic tape, compact disk, DVD, optical storage disk, or any other computer data storage device. Removable storage drive 1114 reads from and/or writes to removable storage unit 1116 in a well-known manner.

Processing device 1100 also includes input/output/display devices 1104, such as touchscreens, LED and LCD displays, monitors, keyboards, pointing devices, etc.

Processing device 1100 further includes a communication or network interface 1120. Communication interface 1120 enables processing device 1100 to communicate with remote devices. For example, communication interface 1120 allows processing device 1100 to communicate over communication networks or mediums 1122 (representing a form of a computer useable or readable medium), such as LANs, WANs, the Internet, etc. Communication interface 1120 may interface with remote sites or networks via wired or wireless connections.

Control logic 1128 may be transmitted to and from processing device 1100 via the communication medium 1122.

Any apparatus or manufacture comprising a computer useable or readable medium having control logic (software) stored therein is referred to herein as a computer program product or program storage device. This includes, but is not limited to, processing device 1100, main memory 1108, secondary storage devices 1110, and removable storage unit 1116. Such computer program products, having control logic stored therein that, when executed by one or more data processing devices, cause such data processing devices to operate as described herein, represent embodiments.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of devices. For instance, embodiments may be included, without limitation, in processing devices (e.g., illustrated in FIG. 11) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. § 101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 1106 of FIG. 11), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A media cable, comprising:
a plurality of conductors;
a first connector at a first end of the media cable configured to connect to a first device;
a second connector at a second end of the media cable configured to connect to a second device, the first connector and the second connector each including a respective plurality of terminals coupled to the plurality of conductors; and
a first detection circuit comprising:
detection logic configured to detect at least one of a state or a state change of at least one of the first device, the second device, or the media cable; and
an indicator configured to receive an indication of the detected at least one of the state or the state change and to generate a notification of the at least one of the state or the state change.

2. The media cable of claim 1, wherein the first detection circuit is positioned adjacent to the first end of the media cable, and the media cable further comprises:
a second detection circuit positioned adjacent to the second end of the media cable and configured to detect at least one of a state or a state change of a least one of the first device or the second device.

3. The media cable of claim 1, wherein the first detection circuit further comprises a switch, and the detection logic is configured to cause the indicator to generate a notification in response to the switch being actuated.

4. The media cable of claim 1, wherein the at least one of the state or the state change indicates at least one of: (i) a connection of the media cable to the first device, (ii) a disconnection of the media cable from the first device, (iii) a connection of the media cable to the second device, (iv) a disconnection of the media cable from the second device, (v) a power state of the first device, or (vi) a power state of the second device.

5. The media cable of claim 1, wherein the detection logic comprises at least one multivibrator coupled to at least one conductor of the plurality of conductors.

6. The media cable of claim 1, wherein the detection logic comprises a microcontroller coupled to at least one conductor of the plurality of conductors.

7. The media cable of claim 6, wherein the microcontroller is programmed to monitor the at least one conductor to detect the at least one of a state or a state change and to control at least one of a type, a duration, or a rate of the notification of the at least one of the state or the state change.

8. The media cable of claim 6, wherein the at least one conductor comprises a Display Data Channel (DDC) communication line.

9. The media cable of claim 6, wherein the at least one conductor comprises a Consumer Electronics Control (CEC) communication line.

10. The media cable of claim 1, wherein the plurality of conductors comprises a power conductor that receives power from at least one of the first device or second device.

11. A detection circuit of a media cable, comprising:
detection logic configured to detect at least one of a state or a state change of at least one of the media cable or a device connected to the media cable; and
an indicator configured to receive an indication of the detected at least one of the state or the state change and to generate a notification based on the at least one of the state or the state change.

12. The detection circuit of claim 11, further comprising a switch, the first detection logic configured to cause the indicator to generate a notification in response to the switch being actuated.

13. The detection circuit of claim 11, wherein the detection logic comprises at least one multivibrator coupled to at least one conductor of a plurality of conductors of the media cable.

14. The detection circuit of claim 11, wherein the detection logic comprises a microcontroller coupled to at least one conductor of a plurality of conductors of the media cable.

15. The detection circuit of claim 14, wherein the microcontroller is programmed to monitor the at least one conductor to detect the at least one of a state or a state change and to control at least one of a type, a duration, or a rate of the notification of the at least one of the state or the state change.

16. A method in a media cable, comprising:
detecting at least one of a state or a state change of the media cable or a first device connected to the media cable; and
generating a notification of the at least one of the state or the state change.

17. The method of claim 16, wherein said detecting comprises:
detecting at least one of a state or a state change of a second device connected to the media cable.

18. The method of claim 17, wherein said generating comprises:
generating a notification of the state or the state change of the second device.

19. The method of claim 17, wherein said detecting comprises:
detecting at least one of
a connection of the media cable to the first device,
a disconnection of the media cable from the first device,
a connection of the media cable to the second device,
a disconnection of the media cable from the second device,
a change in a power state of the first device, or
a change in the power state of the second device.

20. The method of claim 16, further comprising:
detecting actuation of a switch of the media cable by a user; and generating a notification in response to said detecting of the actuation.
